(19) United States
(12) Patent Application Publication
(10) Pub. No.: US 2023/0025107 A1
(43) Pub. Date: Jan. 26, 2023

(54) ELECTROCHEMICAL DEVICE

(71) Applicant: Panasonic Intellectual Property Management Co., Ltd., Osaka (JP)

(72) Inventor: KENICHI NAGAMITSU, Kyoto (JP)

(21) Appl. No.: 17/906,414

(22) PCT Filed: Mar. 29, 2021
(86) PCT No.: PCT/JP2021/013178

§ 371 Date: Sep. 15, 2022

(30) Foreign Application Priority Data
Mar. 30, 2020 (JP) 2020-061362

(51) Int. Cl. H01M 4/60; H01M 10/0525

(52) U.S. Cl. CPC H01M 4/606; H01M 10/0525; H01M 2004/028

(57) ABSTRACT

An electrochemical device includes a positive electrode containing a positive electrode active material, a negative electrode containing a negative electrode active material, and an electrolytic solution. The positive electrode active material contains a conductive polymer, and the electrolytic solution contains anions with which the conductive polymer is doped and dedoped. In the discharged state, the concentration of the anions in the electrolytic solution is in the range from 1.1 mol/L to 1.6 mol/L, inclusive.

### TECHNICAL FIELD

The present invention relates to an electrochemical device that includes an active layer containing a conductive polymer.

### BACKGROUND

In recent years, an electrochemical device having performance intermediate between a lithium ion secondary battery and an electric double layer capacitor attracts attention, and for example, use of a conductive polymer as a positive electrode material is considered (for example, PTL 1). Since the electrochemical device containing the conductive polymer as the positive electrode material is charged and discharged by adsorption (doping) and desorption (dedoping) of anions, the electrochemical device has a small reaction resistance and has higher output than output of a general lithium ion secondary battery.

As the conductive polymer, polyaniline is expected. PTL 2 discloses a positive electrode for a power storage device containing polyaniline and having a proportion of a polyaniline oxidized body to the entire polyaniline in the range from 0.01% to 75%, inclusive.

### CITATION LIST

### Patent Literature

PTL 1: Unexamined Japanese Patent Publication No. 2014-35836

PTL 2: Unexamined Japanese Patent Publication No. 2014-130706

### SUMMARY

However, even when the positive electrode disclosed in PTL 1 or 2 is used, an electrochemical device having sufficient characteristics may not be obtained. In particular, it is difficult to maintain the internal resistance low in both the charged and discharged states.

In view of the above problems, one aspect of the present invention relates to an electrochemical device that includes a positive electrode including a positive electrode active material, a negative electrode including a negative electrode active material, and an electrolytic solution. The positive electrode active material contains a conductive polymer. The electrolytic solution contains anions with which the conductive polymer is doped and dedoped. A concentration of the anions in the electrolytic solution in a discharged state is in a range from 1.1 mol/L to 1.6 mol/L, inclusive.

With the present invention, the internal resistance of the electrochemical device can be kept low in both the charged state and the discharged state.

### BRIEF DESCRIPTION OF THE DRAWINGS

FIG. 1 is a vertical cross-sectional view illustrating a configuration of an electrochemical device according to an exemplary embodiment of the present invention.

### DESCRIPTION OF EMBODIMENT

An electrochemical device according to an exemplary embodiment of the present disclosure includes a positive electrode including a positive electrode active material, a negative electrode including a negative electrode active material, and an electrolytic solution. The positive electrode active material contains a conductive polymer. The electrolytic solution contains anions with which the conductive polymer is doped and dedoped. In the discharged state, the concentration of the anions in the electrolytic solution is in the range from 1.1 mol/L to 1.6 mol/L, inclusive.

In the above description, the charged state is intended to be a state in which the depth of discharge (ratio of the discharge amount to the full charge capacitance) of the electrochemical device becomes less than or equal to 10%. And an end-of-charge voltage is defined as the voltage between terminals at the time when the charging has been completed to be in this state. Further, the discharged state is intended to be a state in which the depth of discharge of the electrochemical device becomes more than or equal to 90%. And an end-of-discharge voltage is defined as the voltage between terminals at the time when the discharging has been completed to be in this state. The end-of-charge voltage can be determined according to the design of the electrochemical device such that the depth of discharge is in the range from 0% to 10%, inclusive. And the end-of-discharge voltage can be determined according to the design of the electrochemical device such that the depth of discharge is in the range from 90% to 100%, inclusive. The end-of-charge voltage and the end-of-discharge voltage are determined by the combination of the positive electrode material and the negative electrode material. For example, when a π-conjugated polymer is used as the conductive polymer and a carbon material in which lithium ions can be inserted and desorbed is used as the negative electrode material, for example, the end-of-charge voltage can be set in the range from 3.6 V to 3.9 V inclusive, and the end-of-discharge voltage can be set in the range from 2.0 V to 2.7 V inclusive. Typically, the charged state refers to a state in which the battery is charged to a voltage of 3.6 V. The discharged state refers to a state in which the charged electrochemical device is discharged to a voltage of 2.7 V.

In the electrochemical device of the present exemplary embodiment, the anions move to the positive electrode in accordance with charging, so that the conductive polymer is doped. On the other hand, during discharging, dedoping of the anions is performed, and the anions are released into the electrolytic solution. In the negative electrode, for example, as the same in the lithium ion battery, cations (such as lithium ions) are occluded in the negative electrode active material during charging, and the cations are released into the electrolytic solution during discharging.

Hence, unlike the lithium ion secondary battery, in the electrochemical device, the anion concentration (salt concentration) in the electrolytic solution changes with charging and discharging. The anion concentration (salt concentration) is low in the charged state and high in the discharged state. When the anion concentration in the discharged state is low, the anion concentration becomes too low in the charged state, and the ionic conductivity of the electrolytic solution may decrease. As a result, the internal resistance (DCR) at the time of discharging from the charged state increases, and rapid discharge may be difficult.

In order to suppress an increase in internal resistance (DCR) at the time of discharge (charged state) and enable rapid discharge, it is also conceivable to increase the anion concentration by increasing the amount of anions added to the electrolytic solution in advance. However, when the anion concentration in the discharged state is high, the viscosity of the electrolytic solution increases, and thus the ionic conductivity may decrease. As a result, the internal resistance (DCR) at the time of charging from the discharged state increases, and rapid charge may be difficult.

In general, the ionic electrical conductivity in the electrolytic solution has a distribution of a mountain shape with a peak, which increases to a maximum value and then decreases as the anion concentration (salt concentration) increases. The anion concentration can be set to fall within a predetermined range including this peak. In order to take advantage of the electrochemical device capable of rapid discharge and rapid charge, the anion concentration is preferably within the predetermined range in both the charged state and the discharged state.

In the electrochemical device of the present exemplary embodiment, by controlling the amount of anions in the electrolytic solution so that the anion concentration during discharging will fall within the range from 1.1 mol/L to 1.6 mol/L, inclusive, the ionic electrical conductivity of the electrolytic solution can be easily maintained high in both the charged state and the discharged state. This makes it possible to realize an electrochemical device excellent in discharge characteristics and charge characteristics. In the discharged state, the anion concentration may be in the range from 1.2 mol/L to 1.6 mol/L, inclusive.

In this case, the anion concentration in the electrolytic solution in the charged state of the electrochemical device may be in the range from 0.65 mol/L to 1.0 mol/L, inclusive, more preferably from 0.8 mol/L to 1.0 mol/L, inclusive.

The anion concentration in the discharged state is obtained by analyzing an extracted electrolytic solution by ion chromatography after disassembling the electrochemical device discharged at a constant current of 0.03 A per a weight of 1 g of the conductive polymer until the voltage between terminals becomes 2.7 V. Similarly, the anion concentration in the charged state is obtained by analyzing an extracted electrolytic solution by ion chromatography after disassembling the electrochemical device charged at a constant current of 0.03 A per a weight of 1 g of the conductive polymer until the voltage between terminals becomes 3.6 V.

For example, the conductive polymer includes polyaniline. Polyaniline is a polymer containing aniline (C₆H₅—NH₂) as a monomer. Polyaniline includes polyaniline and derivatives thereof. The polyaniline of the present invention includes, for example, a compound containing a benzene ring to a part of which an alkyl group such as a methyl group is attached and a derivative containing a benzene ring to a part of which a halogen group or the like is attached, as long as the compound and the derivative are polymers containing aniline as a basic skeleton.

The structure of polyaniline includes a structural unit (also referred to as an IP structure) capable of forming a benzonoid skeleton of (—C₆H₄—NH—) and a structural unit (also referred to as an NP structure) capable of forming a quinoid skeleton of (—C₆H₄═N—). The ratio between the IP structure and the NP structure varies depending on the conditions at the time of polyaniline synthesis or the oxidation state. Here, when the structure of polyaniline is represented as (—(IP)ₙ(NP)ₘ—), the ratio n/m is referred to as an IP/NP ratio. The IP/NP ratio may be in the range from 1.1 to 1.7, inclusive or from 1.2 to 1.6, inclusive, in the discharged state.

When the IP/NP ratio is small, doping/dedoping with the anions hardly occurs, and the capacitance is reduced. In addition, the internal resistance tends to increase in both charging and discharging. On the other hand, although the capacitance can be increased by increasing the IP/NP ratio, if the IP/NP ratio is too large, the performance in a high temperature environment and a high temperature float (low voltage load environment) condition is deteriorated, and the reliability may be deteriorated.

Furthermore, when the IP/NP ratio is increased in order to obtain a high capacitance, the doping/dedoping amount of the anions increases. Thus, the difference in anion concentration between charging and discharging increases. As a result, it may be difficult to keep the anion concentration within a predetermined range and maintain the ionic electrical conductivity of the electrolytic solution high in both the charged state and the discharged state.

By setting the IP/NP ratio in the range from 1.1 to 1.7, inclusive, more preferably from 1.2 to 1.6, inclusive, at the time of discharging, it is possible to realize an electrochemical device in which performance deterioration is suppressed even under a high temperature environment and a high temperature float (low voltage load environment) condition while a high capacitance is maintained and an increase in internal resistance is suppressed. In addition, in both the charged state and the discharged state, the anion concentration of the electrolytic solution can be maintained within a predetermined range in which high ionic electrical conductivity is obtained, and excellent discharge characteristics and charge characteristics are obtained.

The IP/NP ratio can be measured by performing FT-IR spectroscopy on the positive electrode active material taken out from the electrochemical device. The measured IR spectrum has a first peak attributed to nitrogen atoms of the IP structure and a second peak attributed to nitrogen atoms of the NP structure. The first peak usually appears in the range from 1,460 cm⁻¹ to 1,540 cm⁻¹, inclusive. The second peak usually appears in the range from 1,550 cm⁻¹ to 1,630 cm⁻¹, inclusive. The IP/NP ratio is determined from the ratio of the integrated intensity of the first peak to the integrated intensity of the second peak.

The IR spectrum may be measured for the positive electrode active material on the surface of the sample obtained by sufficiently washing and drying the positive electrode.

As described above, the capacitance can be maintained high by increasing the IP/NP ratio. On the other hand, due to the high capacitance, doping/dedoping of many anions occurs during charging and discharging. That is, the higher the capacitance, the larger the difference in anion concentration between discharging and charging. Thus, it becomes difficult to keep the anion concentration within a predetermined range in which the ionic electrical conductivity of the electrolytic solution is high in both discharging and charging.

In order to reduce the difference in anion concentration between discharging and charging, it is also possible to increase the total amount of anions contained in the electrolytic solution while maintaining the anion concentration so as not to be excessively high by increasing the amount of the electrolytic solution. However, as the amount of the electrolytic solution increases, the space (gap) in the cell decreases. As a result, the internal pressure of the device is greatly affected by expansion and contraction of the positive and negative electrodes due to charging and discharging and gas generation caused by charging and discharging. In order to suppress the increase in the internal pressure, the ratio AB of a mass A of the electrolytic solution to a mass B of the conductive polymer may be in the range from 3.7 to 7.2, inclusive.

### Electrochemical Device

Hereinafter, a configuration of the electrochemical device according to the present invention will be described in more detail with reference to the drawing.

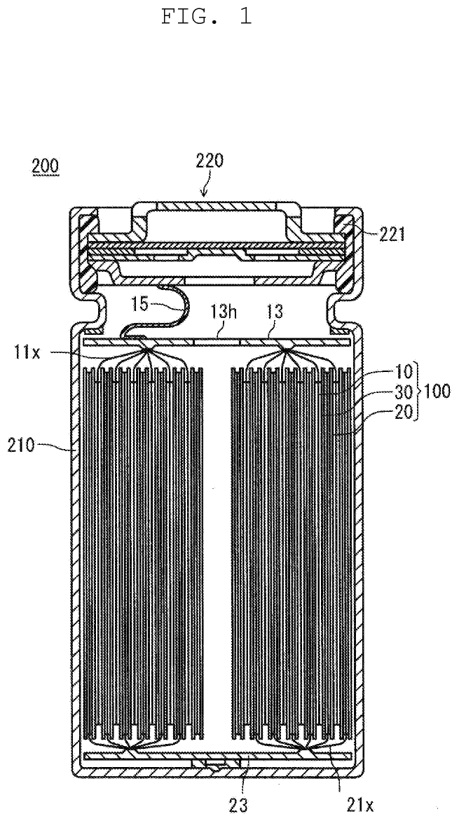

FIG. 1 is a longitudinal cross-sectional view illustrating an outline of a configuration of electrochemical device 200 according to one exemplary embodiment of the present invention. Electrochemical device 200 is provided with electrode body 100, a non-aqueous electrolytic solution (not shown), metallic bottomed cell case 210 housing electrode body 100 and the non-aqueous electrolytic solution, and sealing plate 220 sealing an opening of cell case 210.

Electrode body 100 is configured as a columnar wound body by, for example, winding a belt-shaped negative electrode and a belt-shaped positive electrode together with a separator interposed between them. Electrode body 100 may also be formed as a stacked body in which a plate-like positive electrode and a plate-like negative electrode are stacked with a separator interposed between them. The positive electrode is provided with a positive electrode core material and a positive electrode material layer supported by the positive electrode core material. The negative electrode is provided with a negative electrode core material and a negative electrode material layer supported by the negative electrode core material.

Gasket 221 is disposed on the peripheral edge of sealing plate 220, and the open end of cell case 210 is caulked by gasket 221, whereby the inside of cell case 210 is sealed. Positive electrode current collecting plate 13 having through hole 13h in the center is welded to positive-electrode-core-material exposed part 11x. The other end of tab lead 15 having one end connected to positive electrode current collecting plate 13 is connected to an inner surface of sealing plate 220. Thus, sealing plate 220 has a function as an external positive electrode terminal. On the other hand, negative electrode current collecting plate 23 is welded to negative-electrode-core-material exposed part 21x. Negative electrode current collecting plate 23 is directly welded to a welding member disposed on the inner bottom surface of cell case 210. Thus, cell case 210 has a function as an external negative electrode terminal.

(Positive Electrode Core Material)

A sheet-shaped metallic material is used as the positive electrode core material. The sheet-shaped metallic material may be a metal foil, a porous metal body, an etched metal, or the like. As the metallic material, aluminum, aluminum alloy, nickel, titanium, or the like can be used. The thickness of the positive electrode core material is, for example, in the range from 10 μm to 100 μm inclusive. A carbon layer may be formed on the positive electrode core material. The carbon layer is interposed between the positive electrode core material and the positive electrode material layer and has a function of, for example, reducing the resistance between the positive electrode core material and the positive electrode material layer and improving the current collecting property from the positive electrode material layer to the positive electrode core material.

(Carbon Layer)

The carbon layer is formed, for example, by depositing a conductive carbon material on the surface of the positive electrode core material or forming a coating film of a carbon paste containing a conductive carbon material and drying the coating film. The carbon paste includes, for example, a conductive carbon material, a polymer material, and water or an organic solvent. The thickness of the carbon layer may be, for example, in the range from 1 μm to 20 μm inclusive. As the conductive carbon material, graphite, hard carbon, soft carbon, carbon black, or the like may be used. Among them, carbon black may form a thin carbon layer having excellent conductivity. As the polymer material, fluorine resin, acrylic resin, polyvinyl chloride, styrene-butadiene rubber (SBR), or the like may be used.

(Positive Electrode Material Layer)

The positive electrode material layer contains a conductive polymer as a positive electrode active material. The positive electrode material layer is formed, for example, by immersing the positive electrode core material provided with the carbon layer in a reaction solution containing a raw material monomer of the conductive polymer and electrolytically polymerizing the raw material monomer in the presence of the positive electrode core material. At this time, by performing electrolytic polymerization with the positive electrode core material as an anode, the positive electrode material layer containing the conductive polymer is formed so as to cover the carbon layer. The thickness of the positive electrode material layer can be controlled by the electrolytic current density, the polymerization time, and the like. The thickness of the positive electrode material layer is, for example, in the range from 10 μm to 300 μm, inclusive, per surface. The weight-average molecular weight of the conductive polymer is not particularly limited and, for example, in the range from 1,000 to 100,000, inclusive.

The positive electrode material layer may be formed by a method other than electrolytic polymerization. For example, the positive electrode material layer containing a conductive polymer may be formed by chemical polymerization of a raw material monomer. The positive electrode material layer may also be formed by using a conductive polymer synthesized in advance or a dispersion thereof.

In the present exemplary embodiment, the conductive polymer includes polyaniline. When the positive electrode material layer contains polyaniline as a conductive polymer, the proportion of the polyaniline to all conductive polymers constituting the positive electrode material layer may be more than or equal to 90 mass %.

Electrolytic polymerization or chemical polymerization may be carried out with a reaction solution containing a dopant. An π-electron conjugated polymer doped with a dopant exhibits excellent conductivity. For example, in chemical polymerization, the positive electrode core material may be immersed in a reaction solution containing a dopant, an oxidizing agent, and a raw material monomer, then withdrawn from the reaction solution, and dried. In the electrolytic polymerization, the positive electrode core material and a counter electrode may be immersed in a reaction solution containing a dopant and a raw material monomer, and a current may flow between the positive electrode core material as an anode and the counter electrode as a cathode.

The positive electrode material layer may contain a conductive polymer other than the polyaniline. As the conductive polymer usable together with the polyaniline, a π-conjugated polymer is preferable. Examples of the π-conjugated polymer that can be used include polypyrrole, polythiophene, polyfuran, polythiophene vinylene, polypyridine, and derivatives of these polymers. A weight-average molecular weight of the conductive polymer is not particularly limited and ranges from 1,000 to 100,000, inclusive, for example. As a raw material monomer of the conductive polymer usable together with the polyaniline, it is possible to use, for example, pyrrole, thiophene, furan, thiophene vinylene, pyridine, and derivatives of these monomers. The raw material monomer may include an oligomer.

Derivatives of polypyrrole, polythiophene, polyfuran, polythiophene vinylene, and polypyridine mean polymers having, as a basic skeleton, polypyrrole, polythiophene, polyfuran, polythiophene vinylene, and polypyridine, respectively. For example, a polythiophene derivative includes poly(3,4-ethylenedioxythiophene) (PEDOT) and the like.

As described above, the IP/NP ratio of polyaniline contained in the positive electrode material layer is in the range from 1.1 to 1.7 inclusive, more preferably in the range from 1.2 to 1.6 inclusive, when the electrochemical device is discharged. The IP/NP ratio can be controlled by, for example, the temperature during polymerization. As the temperature during polymerization is higher, the IP/NP ratio tends to be higher. In addition, the IP/NP ratio can also be adjusted by changing reduction conditions when dedoping with the dopant of the conductive polymer is performed, for example, conditions such as the type of a reducing agent, the amount of the reducing agent, the reduction temperature, the reduction time, and/or the voltage applied at the time of reduction, or the atmosphere and time when the obtained positive electrode is left at a high temperature.

The electrolytic polymerization or the chemical polymerization is preferably performed using a reaction solution containing a dopant. The dispersion liquid or the solution of the conductive polymer also preferably contains a dopant. A π-electron conjugated polymer doped with a dopant exhibits excellent conductivity. For example, in chemical polymerization, the positive electrode core material may be immersed in a reaction solution containing a dopant, an oxidizing agent, and a raw material monomer, then withdrawn from the reaction solution, and dried. In the electrolytic polymerization, the positive electrode core material and a counter electrode may be immersed in a reaction solution containing a dopant and a raw material monomer, and a current may flow between the positive electrode core material as an anode and the counter electrode as a cathode.

As the solvent of the reaction solution, water may be used, or a non-aqueous solvent may be used in consideration of solubility of the monomer. As the non-aqueous solvent, preferably used are, for example, alcohols such as ethyl alcohol, methyl alcohol, isopropyl alcohol, ethylene glycol, and propylene glycol. A dispersion medium or solvent of the conductive polymer is also exemplified by water and the non-aqueous solvents described above.

Examples of the dopant include a sulfate ion, a nitrate ion, a phosphate ion, a borate ion, a benzenesulfonate ion, a naphthalenesulfonate ion, a toluenesulfonate ion, a methanesulfonate ion (CF₃SO₃⁻), a perchlorate ion (ClO₄⁻), a tetrafluoroborate ion (BF₄⁻), a hexafluorophosphate ion (PF₆⁻), a fluorosulfate ion (FSO₃⁻), a bis(fluorosulfonyl)imide ion (N(FSO₂)₂⁻), and a bis(trifluoromethanesulfonyl)imide ion (N(CF₃SO₂)₂⁻). These may be used alone or may be used in combination of two or more kinds.

The dopant may be a polymer ion. Examples of the polymer ion include ions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These dopants may be a homopolymer or a copolymer of two or more monomers. These may be used alone or may be used in combination of two or more kinds.

(Positive Electrode Current Collecting Plate)

The positive electrode current collecting plate is a metal plate having a substantially disk shape. It is preferable to form a through hole serving as a passage for the non-aqueous electrolyte in the central part of the positive electrode current collecting plate. The material of the positive electrode current collecting plate is, for example, aluminum, aluminum alloy, titanium, stainless steel, or the like. The material of the positive electrode current collecting plate may be the same as the material of the positive electrode core material.

(Negative Electrode Core Material)

A sheet-shaped metallic material is also used for the negative electrode core material. The sheet-shaped metallic material may be a metal foil, a porous metal body, an etched metal, or the like. As the metallic material, copper, copper alloy, nickel, stainless steel, or the like may be used. The thickness of the negative electrode core material is, for example, in the range from 10 μm to 100 μm, inclusive.

(Negative Electrode Material Layer)

The negative electrode material layer includes a material that electrochemically absorbs and releases lithium ions as a negative electrode active material. Examples of such a material include a carbon material, a metal compound, an alloy, and a ceramic material. As the carbon material, graphite, hardly-graphitizable carbon (hard carbon), and easily-graphitizable carbon (soft carbon) are preferable, and graphite and hard carbon are particularly preferable. Examples of the metal compound include silicon oxides and tin oxides. Examples of the alloy include silicon alloys and tin alloys. Examples of the ceramic material include lithium titanate and lithium manganate. These may be used alone or may be used in combination of two or more kinds. Among these materials, a carbon material is preferable in terms of being capable of decreasing a potential of the negative electrode.

The negative electrode material layer may contain a conductive agent, a binder, and the like in addition to the negative electrode active material. Examples of the conductive agent include carbon black and carbon fiber. Examples of the binder include a fluorine resin, an acrylic resin, a rubber material, and a cellulose derivative.

The negative electrode material layer is formed by, for example, mixing the negative electrode active material, the conductive agent, the binder, and the like with a dispersion medium to prepare a negative electrode mixture paste, applying the negative electrode mixture paste to the negative electrode core material, and then drying the negative electrode mixture paste. The thickness of the negative electrode material layer is, for example, in the range from 10 μm to 300 μm, inclusive, per surface.

The negative electrode material layer is preferably pre-doped with lithium ions in advance. This decreases the potential of the negative electrode and thus increases a difference in potential (that is, voltage) between the positive electrode and the negative electrode and improves energy density of the electrochemical device.

Pre-doping of the negative electrode with the lithium ions is progressed by, for example, forming a metallic lithium layer that is to serve as a supply source of lithium ions on a surface of the negative electrode material layer and impregnating the negative electrode including the metallic lithium layer with an electrolytic solution (for example, a non-aqueous electrolytic solution) having lithium ion conductivity. At this time, lithium ions are eluted from the metallic lithium layer into the non-aqueous electrolytic solution, and the eluted lithium ions are occluded in the negative electrode active material. For example, when graphite or hard carbon is used as the negative electrode active material, lithium ions are inserted in between layers of graphite or in fine pores of hard carbon. The amount of lithium ions for the pre-doping may be controlled by the mass of the metallic lithium layer. The amount of lithium for the pre-doping may be, for example, in the range from about 50% to 95%, inclusive of the maximum amount that can be occluded in the negative electrode material layer.

The step of pre-doping the negative electrode with lithium ions may be performed before the electrode group is assembled, or the pre-doping may be progressed after the electrode group is housed in a case of the electrochemical device together with the non-aqueous electrolytic solution.

(Negative Electrode Current Collecting Plate)

The negative electrode current collecting plate is a metal plate having a substantially disk shape. The material of the negative electrode current collecting plate is, for example, copper, copper alloy, nickel, stainless steel, or the like. The material of the negative electrode current collecting plate may be the same as the material of the negative electrode core material.

(Separator)

As the separator, a nonwoven fabric made of cellulose fiber, a nonwoven fabric made of glass fiber, a microporous film made of polyolefin, a woven fabric, a nonwoven fabric, or the like may be used. The thickness of the separator is, for example, in the range from 10 μm to 300 μm, inclusive, preferably from 10 μm to 40 μm, inclusive.

(Electrolytic Solution)

The electrolytic solution has ion conductivity and contains anions, cations, and a solvent that dissolves the anions and the cations. In this case, doping and dedoping of the positive electrode with the anions can be reversibly repeated. On the other hand, the cations are reversibly occluded into and released from the negative electrode. Usually, the anions and the cations are added to the solvent in the form of a salt of the anions and the cations. The cations may be lithium ions. In this case, the electrolytic solution contains a lithium salt. The anion concentration (salt concentration) in the electrolytic solution is in the range from 1.1 mol/L to 1.6 mol/L, inclusive, in the discharged state.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. These lithium salts may be used alone or in combination of two or more of these lithium salts. Among these lithium salts, preferably used are at least one selected from the group consisting of a lithium salt having a halogen atom-containing oxo acid anion suitable as the anions, and a lithium salt having an imide anion. It is preferable to use an electrolytic solution containing lithium hexafluorophosphate from the viewpoint of enhancing the ion conductivity of the electrolytic solution and suppressing corrosion of metal parts such as current collectors and leads.

The solvent may be a non-aqueous solvent. As the non-aqueous solvent, it is possible to use, for example, cyclic carbonates such as ethylene carbonate, propylene carbonate, and butylene carbonate; chain carbonates such as dimethyl carbonate, diethyl carbonate, and ethyl methyl carbonate; aliphatic carboxylate esters such as methyl formate, methyl acetate, methyl propionate, and ethyl propionate; lactones such as γ-butyrolactone (GBL) and γ-valerolactone; chain ethers such as 1,2-dimethoxyethane (DME), 1,2-diethoxyethane (DEE), and ethoxymethoxyethane (EME); cyclic ethers such as tetrahydrofuran and 2-methyltetrahydrofuran; dimethyl sulfoxide, 1,3-dioxolane, formamide, acetamide, dimethylformamide, dioxolane, acetonitrile, propionitrile, nitromethane, ethylmonoglyme, trimethoxymethane, sulfolane, methyl sulfolane, and 1,3-propanesultone. These may be used alone or in combination of two or more thereof.

The non-aqueous electrolytic solution may contain an additive agent in the non-aqueous solvent as necessary. For example, an unsaturated carbonate such as vinylene carbonate, vinyl ethylene carbonate, or divinyl ethylene carbonate may be added as an additive agent (coating film formation agent) for forming a coating having high lithium ion conductivity on the surface of the negative electrode.

In the above-described exemplary embodiment, a wound electrochemical device having a cylindrical shape has been described. The scope of application of the present invention is not limited to the exemplary embodiment described above, and the present invention is also applicable to a wound or laminated electrochemical device having a rectangular shape.

### EXAMPLES

Hereinafter, the present invention will be described in more detail based on examples, but the present invention is not limited to the examples.

### Electrochemical Devices A1 to A22, B1 to B3

(1) Production of Positive Electrode

An aluminum foil having a thickness of 30 μm was prepared as a positive current collector. An aqueous aniline solution containing aniline and sulfuric acid was prepared.

A carbon paste obtained by kneading carbon black with water was applied to entire front and back surfaces of the positive current collector and then dried by heating to form a carbon layer. The carbon layer had a thickness of 2 μm per surface.

The positive current collector on which the carbon layer had been formed and an opposite electrode were immersed in the aqueous aniline solution containing sulfuric acid, and electrolytic polymerization was performed at a current density of 10 mA/cm² for 20 minutes to attach a layer of a conductive polymer (polyaniline) doped with sulfate ions (SO₄²⁻) onto the carbon layer on the front and back surfaces of the positive current collector. Thereafter, the positive current collector to which the conductive polymer was attached was placed in a high-temperature environment in an air atmosphere for a predetermined time.

Subsequently, the conductive polymer doped with the sulfate ions was reduced for dedoping of the doping sulfate ions. In this way, a conductive polymer-containing active layer from which sulfate ions had been dedoped was formed. The active layer was then thoroughly washed and then dried. The active layer had a thickness of 35 μm per surface.

(2) Production of Negative Electrode

A copper foil having a thickness of 20 μm was prepared as a negative current collector. A negative electrode mixture paste was prepared by kneading a mixed powder containing 97 parts by mass of hard carbon, 1 part by mass of carboxycellulose, and 2 parts by mass of styrene-butadiene rubber with water at a weight ratio of 40:60. The negative electrode mixture paste was applied to both surfaces of the negative current collector and dried to obtain a negative electrode having a negative electrode material layer having a predetermined thickness on both surfaces. Next, a metallic lithium foil was attached to the negative electrode material layer in an amount calculated such that the negative electrode that was in an electrolytic solution after completion of pre-doping had a potential of less than or equal to 0.2 V with respect to the potential of metallic lithium.

(3) Production of Electrode Group

Lead tabs were respectively connected to the positive electrode and the negative electrode, and then, as shown in FIG. 3, a stacked body in which a nonwoven fabric separator (thickness 35 μm) made of cellulose, the positive electrode, and the negative electrode are alternately stacked on each other was wound to form an electrode group.

(4) Preparation of Electrolytic Solution

A solvent was prepared by adding 0.2 mass % of vinylene carbonate to a mixture of propylene carbonate and dimethyl carbonate in a volume ratio of 1:1. LiPF₆ was dissolved as a lithium salt in the obtained solvent at a predetermined concentration to prepare a non-aqueous electrolytic solution containing hexafluorophosphate ions (PF₆⁻) as the anions.

(5) Production of Electrochemical Device

The electrode group and the electrolytic solution were housed in a bottomed container having an opening to assemble the electrochemical device illustrated in FIG. 2. Thereafter, aging was performed by applying a charge voltage of 3.8 V between terminals of the positive electrode and the negative electrode at 25° C. for 24 hours to progress pre-doping of the negative electrode with lithium ions. In this way, an electrochemical device was fabricated.

By appropriately changing polymerization conditions of polyaniline in preparation of the positive electrode, the thickness of the layer of the conductive polymer (polyaniline), the concentration of the lithium salt added in adjustment of the electrolytic solution and the amount of the electrolytic solution, and the application amount of the negative electrode mixture paste in preparation of the negative electrode, a plurality of electrochemical devices having different combinations of the IP/NP ratio of polyaniline in the discharged state, the anion concentration in the charged/discharged state, the mass A of the electrolytic solution, and the mass B of the positive electrode (mass of the conductive polymer) were prepared. Table 1 shows a list of the IP/NP ratios of polyaniline, the anion concentrations in the charged/discharged state, the masses A of the electrolytic solution, the masses B of the conductive polymer, and the ratios AB of the mass of the electrolytic solution to the mass of the conductive polymer of the respective electrochemical devices. In Table 1, electrochemical devices A1 to A22 are examples, and electrochemical devices B1 to B3 are comparative examples.

In each electrochemical device, the anion concentration and the liquid amount of the electrolytic solution were adjusted so as to have the anion concentration in the charged state shown in Table 1 when charged up to 3.6 V and the anion concentration in the discharged state shown in Table 1 when discharged up to 2.7 V. As for the IP/NP ratio, polyaniline having an IP/NP ratio in the range from 1.1 to 1.8, inclusive, could be synthesized by changing the polymerization temperature during polyaniline polymerization in the range from 40° C. to 60° C., inclusive, and changing the temperature and time in the high temperature treatment step in the air atmosphere after polymerization in the range from 60° C. to 80° C., inclusive, and from 10 minutes to 120 minutes, inclusive.

### Evaluation

(1) Internal Resistance (DCR)

An internal resistance (charge DCR) R₁ during charging was obtained from an amount of voltage drop when the electrochemical device was discharged to a voltage of 2.7 V and then charged for a predetermined time (0.05 seconds to 0.2 seconds) in an environment of 25° C.

Further, an internal resistance (discharge DCR) R₂ during discharging was obtained from an amount of voltage drop when the electrochemical device was charged at a voltage of 3.6 V and then discharged for a predetermined time (0.05 seconds to 0.2 seconds) at 25° C. of the electrochemical device.

(2) DCR Retention Rate

The electrochemical device was charged at a voltage of 3.6 V in an environment of 25° C. The electrochemical device was then placed in an environment of 60° C. for 1,000 hours. After that, an internal resistance (DCR) R₃ after the test was obtained from an amount of voltage drop when the electrochemical device was returned to an environment of 25° C. and discharged for a predetermined time. The ratio R₃/R₂ of R₃ to R₂ was determined, and R₃/R₂×100 was evaluated as a DCR retention rate.

Table 2 shows evaluation results of the internal resistances R₁ and R₂ during charging and discharging and the DCR retention rate in electrochemical devices A1 to A22, B1 to B3.

From Tables 1 and 2, in electrochemical devices A1 to A22 in which the anion concentrations in the discharged state are in the range from 1.1 mol/L to 1.6 mol/L, inclusive, the increase in the internal resistance R₁ during charging and the internal resistance R₂ during discharging can be suppressed as compared with electrochemical devices B1 to B3.

TABLE 1

| | | Anion concentration | | | | |
|---|---|---|---|---|---|---|
| | | Discharged | Charged | Mass A of | Mass B of | |
| | IP/NP | state | state | electrolytic | conductive | |
| | ratio | (mol/L) | (mol/L) | solution (g) | polymer (g) | A/B |
| B1 | 1.4 | 1.0 | 0.5 | 13.0 | 1.81 | 7.2 |
| A1 | 1.4 | 1.1 | 0.6 | 13.0 | 1.81 | 7.2 |
| A2 | 1.4 | 1.4 | 0.9 | 13.0 | 1.81 | 7.2 |
| A3 | 1.4 | 1.6 | 1.1 | 13.0 | 1.81 | 7.2 |
| B2 | 1.4 | 1.7 | 1.2 | 13.0 | 1.81 | 7.2 |
| A4 | 1.4 | 1.33 | 0.6 | 8.2 | 1.81 | 4.5 |
| A5 | 1.4 | 1.38 | 0.65 | 8.5 | 1.81 | 4.7 |
| A6 | 1.4 | 1.3 | 0.8 | 12.0 | 1.81 | 6.6 |
| A7 | 1.4 | 1.5 | 1.0 | 12.0 | 1.81 | 6.6 |
| B3 | 1.4 | 1.7 | 1.1 | 11.0 | 1.81 | 6.1 |
| A8 | 1.1 | 1.2 | 0.8 | 13.0 | 1.81 | 7.2 |
| A9 | 1.2 | 1.2 | 0.8 | 13.0 | 1.81 | 7.2 |
| A10 | 1.4 | 1.2 | 0.7 | 13.0 | 1.81 | 7.2 |
| A11 | 1.6 | 1.2 | 0.7 | 13.0 | 1.81 | 7.2 |
| A12 | 1.8 | 1.2 | 0.7 | 13.0 | 1.81 | 7.2 |
| A13 | 1.4 | 1.5 | 0.5 | 6.3 | 1.81 | 3.5 |
| A14 | 1.4 | 1.5 | 0.7 | 6.7 | 1.81 | 3.7 |
| A15 | 1.4 | 1.5 | 0.8 | 7.5 | 1.81 | 4.1 |
| A16 | 1.4 | 1.5 | 0.9 | 10.5 | 1.81 | 5.8 |
| A17 | 1.4 | 1.5 | 1.0 | 13.0 | 1.81 | 7.2 |
| A18 | 1.4 | 1.5 | 0.5 | 12.0 | 3.42 | 3.5 |
| A19 | 1.4 | 1.5 | 0.65 | 12.0 | 3.24 | 3.7 |
| A20 | 1.4 | 1.5 | 0.9 | 12.0 | 2.07 | 5.8 |
| A21 | 1.4 | 1.5 | 1.0 | 12.0 | 1.67 | 7.2 |
| A22 | 1.4 | 1.5 | 1.1 | 12.0 | 1.5 | 8.0 |

In electrochemical device B1, since the anion concentration in the discharged state is low and less than 1.1 mol/L, the anion concentration remarkably decreases in the charged state, and the conductivity of the electrolytic solution decreases in the charged state. As a result, the internal resistance R₂ significantly increases during discharging. On the other hand, in electrochemical devices B2 and B3, when the anion concentration in the discharged state is increased to a concentration exceeding 1.6 mol/L, the anion concentration in the charged state is moderate, but the anion concentration in the discharged state becomes too high, so that the conductivity of the electrolytic solution decreases due to an increase in viscosity. As a result, it is difficult to suppress an increase in the internal resistance R₂ during charging.

As shown in electrochemical devices A13 to A22, by increasing the amount of the electrolytic solution with respect to the mass of the conductive polymer and increasing the total amount of anions contained in the electrolytic solution, it is possible to achieve a high capacitance and suppress an increase in internal resistance R₂ during discharging. However, in electrochemical device A22, since the amount of the electrolytic solution was large with respect to the mass of the conductive polymer, the internal pressure of the device was large, and in the evaluation of the DCR retention rate, an explosion-proof valve had been operated when the device was placed in an environment of 60° C. for 1,000 hours.

TABLE 2

| | Charge | Discharge | DCR |
|---|---|---|---|
| | DCR R₁ (mΩ) | DCR R₂ (mΩ) | retention rate |
| B1 | 100 | 180 | 101 |
| A1 | 99 | 130 | 102 |
| A2 | 115 | 100 | 100 |
| A3 | 131 | 98 | 103 |
| B2 | 153 | 100 | 100 |
| A4 | 113 | 142 | 100 |
| A5 | 112 | 120 | 102 |
| A6 | 104 | 100 | 100 |
| A7 | 125 | 100 | 103 |
| B3 | 150 | 100 | 103 |
| A8 | 146 | 139 | 101 |
| A9 | 124 | 104 | 102 |
| A10 | 105 | 106 | 104 |
| A11 | 106 | 107 | 123 |
| A12 | 105 | 108 | 195 |
| A13 | 120 | 144 | 103 |
| A14 | 120 | 125 | 101 |
| A15 | 122 | 101 | 101 |
| A16 | 119 | 97 | 102 |
| A17 | 123 | 99 | 130 |
| A18 | 122 | 144 | 101 |
| A19 | 123 | 129 | 102 |
| A20 | 122 | 98 | 101 |
| A21 | 125 | 100 | 132 |
| A22 | 127 | 99 | — |

### INDUSTRIAL APPLICABILITY

The electrochemical device according to the present invention has excellent rapid charge-discharge characteristics and can be suitably used as various power sources.

### REFERENCE MARKS IN THE DRAWINGS

100 electrode body

10 positive electrode

11x positive-electrode-core-material exposed part

13 positive electrode current collecting plate

15 tab lead

20 negative electrode

21x negative-electrode-core-material exposed part

23 negative electrode current collecting plate

30 separator

200 electrochemical device

210 cell case

220 sealing plate

221 gasket

1. An electrochemical device comprising:
a positive electrode including a positive electrode active material;
a negative electrode including a negative electrode active material; and
an electrolytic solution,
wherein:
the positive electrode active material contains a conductive polymer,
the electrolytic solution contains anions with which the conductive polymer is doped and dedoped, and
a concentration of the anions in the electrolytic solution in a discharged state is in a range from 1.1 mol/L to 1.6 mol/L, inclusive.

2. The electrochemical device according to claim 1, wherein a concentration of the anions in the electrolytic solution in a charged state is in a range from 0.65 mol/L to 1.0 mol/L, inclusive.

3. The electrochemical device according to claim 1, wherein:
the conductive polymer contains polyaniline, and
an IP/NP ratio of the polyaniline in a discharged state is in a range from 1.1 to 1.7, inclusive.

4. The electrochemical device according to claim 1, wherein a ratio A/B of a mass A of the electrolytic solution to a mass B of the conductive polymer is in a range from 3.7 to 7.2, inclusive.
